(19) United States
(12) Patent Application Publication
(10) Pub. No.: US 2025/0382464 A1
(43) Pub. Date: Dec. 18, 2025

(54) WOOD-BASED OBJECTS

(71) Applicant: DAIKA LTD., Rosh Haayin (IL)

(72) Inventors: Michael LAYANI, Petach Tikvah (IL); Ariel ZINGER, Ramat Gan (IL); May MEYERSON, Kfar Yona (IL)

(73) Assignee: DAIKA LTD., Rosh Haayin (IL)

(21) Appl. No.: 18/715,415

(22) PCT Filed: Dec. 21, 2022
(86) PCT No.: PCT/IL2022/051361

§ 371 Date: May 31, 2024

Related U.S. Application Data
(60) Provisional application No. 63/265,789, filed on Dec. 21, 2021.
(60) Provisional application No. 63/373,751, filed on Aug. 29, 2022.

(51) Int. Cl. C08L 97/02; B25H 3/00; B65D 65/46; B65D 73/00; B65D 75/58; B65D 85/24; C08L 89/00

(52) U.S. Cl. CPC C08L 97/02; B65D 65/466; B65D 73/0042; B65D 73/0064; B65D 75/5888; B65D 85/24; C08L 89/00; C08L 89/005; B25H 3/003

(57) ABSTRACT

The technology disclosed herein concerns an all-natural composition for manufacturing of wood-like objects.

### TECHNOLOGICAL FIELD

The invention generally concerns methods of manufacturing wood-based objects and compositions for making same.

### BACKGROUND OF THE INVENTION

Wood products are considered some of the best building materials due to their durability, reusability and for being environmentally friendly. They have two main distinct properties-thermal resistivity and acoustic properties, which can be obtained with a limited number of synthetic or composite materials. In recent years, changes have been implemented in the way wood is utilized for indoor and outdoor uses. While engineered wood products such as laminated veneer lumber, glued laminated timber, finger jointed lumber, oriental strand board and others make a large part of wood products used in constructions, wood products that are based on natural materials only and which do not utilize lamination or other adhesives are rarely manufactured and used.

International Patent Publication WO2019/135245 discloses compositions comprising wood materials along with cellulose nanomaterials for manufacturing all natural wood products.

### BACKGROUND PUBLICATIONS

[1] WO2019/135245

### GENERAL DESCRIPTION

The inventors of the technology disclosed herein have developed a wood-based material that resembles unprocessed wood derived from natural wood sources in its visual appearance, roughness, and mechanical properties. Wood-based products of the invention are manufactured from all-natural compositions, which in some configurations are flowable, which can be molded/extruded to provide out-of-plane 3D products with unique contours and irregular shapes: which could otherwise could be formed only by mechanical shaping of a wood log/panels which would typically require steps of binding the panels together, or through 3D printing.

As will be exemplified below; the wood-based products of the invention are constructed from powdered wood and formed into final solid products by utilizing innovative natural materials never before used in the manufacturing of such products. Prior methodologies for manufacturing wood-based objects, e.g., [1], involved use of a wood material, a cellulose nanomaterial and hemicellulose and/or lignin and/or starch, in compositions free of formaldehyde, synthetic resins and/or epoxy-based materials. Compositions of the invention are different and improved as compared to such compositions, utilizing natural components such as polysaccharides and proteins together with wood-based components that together exhibit effective binding and flowing properties.

Thus, in a first aspect, there is provided an all-natural composition comprising at least one filler, at least one natural binder and water, wherein the at least one filler is a plant-based filler and/or a natural inorganic filler.

The invention further provides an all-natural composition consisting of at least one filler, at least one natural binder and optionally at least one liquid such as water, wherein the at least one filler is a plant-based filler and/or a natural inorganic filler.

The invention further provides a molding composition (namely a composition capable of being molded or for use in a process of molding) comprising or consisting at least one filler, at least one natural binder and water, wherein the at least one filler is a plant-based filler or a natural inorganic filler.

Also provided is a wood-based object formed from a composition comprising or consisting at least one filler and at least one natural binder, wherein the at least one filler is a plant-based filler or a natural inorganic filler.

All compositions of the invention are naturally derived and thus considered “all-natural”. In other words, compositions of the invention utilize products of nature and are substantially free of petroleum-based components. While some of the components used in compositions of the invention have been processed into a desired form suitable for use in accordance with the invention, such a processing is mechanical and does not introduce chemicals or processing agents that may have an effect on the composition and the final product produced therefrom. However, when waste materials are used for manufacturing wood-based materials of the invention, such waste materials can nevertheless include an amount of contaminants which may be derived from a variety of sources. Such contaminants may be derived from the wood source or the waste wood that is used. The amount of contaminants does not typically exceed 10 wt %. In some embodiments, the amount of contaminants is less than 1 wt %. In other words, the non-natural contaminants may be present in an amount between 0 and 10 wt %.

Processed waste products, such as waste wood products, which can be used as components of compositions according to the invention, may comprise a variety of industrial additives that are not naturally derived, bur are rather synthetic or partially synthetic. Such additives, while present in the waste, add nothing to the properties of the composition or products of the invention made therefrom, and may be present in contaminating amounts as indicated herein. The contaminants may be various adhesives, various polymeric materials, pigments, solvents, solubilizing agents and others. Non-limiting examples of contaminants include adhesives, PVC, epoxy, PVA, formaldehyde, isocyanates and others.

Compositions of the invention are further suitable for molding. In other words, they are provided in a flowable form that can flow within a mold and provide a 3D object that is a flat object or an out-of-plane object (not flat) or an object of an irregular shape, wherein the shape and size of the object depends on the mold structure. The ability of compositions of the invention to flow and fill crevices, depressions, or other structural deformities in a mold, enables production of objects of various shapes that are free of air pockets and other defects that may have an effect on the durability of the product, its mechanical properties and on its reproducibility.

Compositions of the invention are putty-like materials that may be tailored to adapt different fluidities and viscosities. In most general terms, in their putty-like form, compositions of the invention may be characterized by one or more of:
viscosity higher than 5K cP but lower than 300M cP, exemplified viscosities are provided in the following table:

| Material | Temp-25° C. η (Pa · s) |
|---|---|
| Municipal waste filler comprising 46% | 81,567 ± 7,212 |
| water, being a composition according to the | |
| invention | |
| Pine filler standard comprising 45% water, | |
| being a composition according to the | 151,188 ± 21,123 |
| invention | |
| Pine filler premium comprising 45% water, | |
| being a composition according to the | 175,288 ± 9,365 |
| invention | |

ability to fill an out-of-plain mold under pressures of <500 ton,
self-drying,
flowing in a screw extruder,
take shape under centrifugal forces,
and others.

Thus, in another aspect of the invention, there is provided an all-natural composition, or a composition for molding, as defined, which comprises at least one filler, at least one natural binder and water, wherein the at least one filler is a plant-based filler and/or a natural inorganic filler, and having a viscosity between 100 KcP and 300 McP. In some embodiments, the viscosity is between 100 Kcp and 100 Mcp.

Also provided is an all-natural composition, or a composition for molding, as defined, which comprises at least one filler, at least one natural binder and water, wherein the at least one filler is a plant-based filler and/or a natural inorganic filler, and wherein the composition has a viscosity permitting molding at a pressure below 500 tons. In some embodiments, the viscosity of the composition is between 100 KcP and 300 McP. In some embodiments, the viscosity is between 100 Kcp and 100 Mcp.

In some embodiments, the composition has a putty-like consistency (i.e., a dough-like consistency) with a viscosity between 5K cP and 300M cP.

Depending on the particular method used and the size of the mold, these compositions of the invention may be modified by modulating, e.g., lowering or increasing, water content or concentration, by modifying ratio of wood particles to binders, by modifying drying methods, or by modifying the molding process.

The at least one “plant-based filler” used in compositions of the invention is typically a powder obtained from ground tree material, ground dried leaves, or ground natural wood waste. The powder may comprise ground material from a single source or a variety of sources. Independent of the source of the filler, the powder is provided as particles having a size ranging from 1 μm to 1 cm.

The amount of the filler in a composition of the invention may be at least 20 wt %.

In some embodiments, the amount of the filler in a composition is between 20 and 60 wt %. In some embodiments, the amount of the filler is between 20 and 60, 20 and 55, 20 and 50, 20 and 45, 20 and 40, 20 and 35, 20 and 30, 20 and 25, 25 and 60, 25 and 55, 25 and 50, 25 and 45, 25 and 40, 25 and 35, 25 and 30, 30 and 60, 30 and 55, 30 and 50, 30 and 45, 30 and 40, 30 and 35, 40 and 60, 40 and 55, 40 and 50, or between 50 and 60 wt %.

In some embodiments, the amount of the filler in a composition of the invention is between 30 and 60, or between 30 and 50, or between 20 and 40, or between 30 and 40 wt %.

In some embodiments, the amount of the filler in a final dry object formed of a composition of the invention may be at least 40 wt %.

In some embodiments, the amount of the filler in a dry object formed of a composition disclosed herein is between 40 and 95 wt %. In some embodiments, the amount of the filler is between 40 and 90, 40 and 85, 40 and 80, 40 and 75, 40 and 70, 40 and 65, 40 and 60, 40 and 55, 40 and 50, 45 and 95, 45 and 85, 45 and 80, 45 and 75, 45 and 60, 45 and 55, 45 and 50, 50 and 90, 50 and 75, 50 and 60, or 50 and 55 wt %.

In some embodiments, the amount of the filler in a dry object formed of a composition of the invention is between 50 and 90, or between 50 and 80, or between 40 and 80, or between 40 and 70 wt %.

The above indicated amount being relevant to any filler disclosed herein, each filler constituting an independent embodiment of the invention.

The ground material may be derived from any part of a tree or a bush, including stalks or branches, trunk or wood bark and leaves. The trees or bushes may be selected from those referred to as hard or soft wood trees or bushes.

In some embodiments, the trees or bushes are selected from ash, basswood, beech, birch, eucalyptus, walnut, pecan, cedar, cherry, elm, gum, hickory, lauan, mahogany, maple, oak, pine, poplar, redwood, rosewood, satinwood, sycamore, teak, alder, apple, aspen, chestnut, cottonwood, cypress, fir, hackberry, hemlock, holly, koa, laurel, locust, magnolia, pear-wood, spruce, tupelo and willow.

In some cases, the ground material is ground dried leaves which may be naturally dry fallen leaves or leaves purposely dried. The leaves may be of any tree or bush as selected above.

The filler may be derived or obtained from waste materials. As used herein, the “waste material” is any such material that is substantially not synthetic, nor comprise synthetic or semi-synthetic components. The waste may be municipal, industrial or agricultural waste, provided that it consists or essentially consists (namely comprises up to 1 wt % or up to 10 wt % non-natural contaminants) natural components that can be ground into powder, as disclosed herein. In some embodiments, the waste material is garden and plant or tree-based waste. The waste material can be classified into two groups: the first-all natural (containing less than 1 wt % containments) wood waste which is typically obtained from large wood industries such as sawmills or municipal waste and the second-contaminated wood waste which might consist between 1 and 10% contaminants such as those found in furniture manufacturing. Utilizing either group, the process and composition mentioned herein results in similar mechanical and processing properties.

The amount of the waste material in compositions and final products of the invention may vary. In some embodiments, the composition and the final products formed therefrom are free of waste material. In some embodiments, the composition and the final products formed therefrom comprise an amount of a waste material, which nature, composition, purity (in terms of containing or not containing non-natural components), and amount may vary based on the origin of the waste material.

The waste material may be derived from a variety of sources, may be used as is, or may be preprocessed to remove non-natural components, to dilute or minimize or reduce the amounts of the non-natural components or to enrich the waste material with one or more additives or materials. The source of the material and any preprocessing steps preceding the steps disclosed herein are outside of the scope of the present invention.

In some cases, where waste material is used, both the filler and the binder used in compositions of the invention may be derived from the waste material. As such, compositions and products derived therefrom may comprise only or substantially only waste materials. Typically, and as noted, the waste materials are derived from or are or consist natural materials and optionally an amount of contaminants as disclosed herein.

The amount of waste materials used in compositions of the invention may thus reach a maximum amount of 99, 98, 97, 96, 95, 94, 93, 92, 91 or 90 wt %. In some embodiments, the waste material may constitute 1 wt % or more of the weight of a composition of the invention. In other words, the amount of waste materials used may range from 1 to 99 wt %, provided that both the filler and the binder components, as defined and selected, are present or derived from the waste material used.

In some embodiments, a composition of the invention may comprise at least 60 wt % of its weight a waste material(s). In some embodiments, a final dry object formed of a composition of the invention may comprise at least 60 wt % of a waste material(s).

In some embodiments, the amount of the waste material in a composition is between 60 and 99 wt %. In some embodiments, the amount of the filler is between 60 and 99, 60 and 98, 60 and 97, 60 and 96, 60 and 95, 60 and 94, 60 and 93, 60 and 92, 60 and 91, 60 and 90, 70 and 99, 75 and 99, 80 and 99, 85 and 99, 90 and 99, 60 and 70, 60 and 80, 70 and 99, 70 and 98, 70 and 97, 70 and 96, 70 and 95, 70 and 90, 70 and 85, or between 70 and 80 wt %.

In some embodiments, the amount of the waste material in a composition of the invention is between 60 and 99, or between 60 and 80, or between 70 and 99, or between 70 and 80 wt %.

The amount of waste materials used in a dry object manufactured from a composition of the invention may thus reach a maximum amount of 99, 98, 97, 96, 95, 94, 93, 92, 91 or 90 wt %. In some embodiments, the waste material may constitute at least 60 wt % of the weight of a composition of the invention and at least 60 wt % of the weight of a final dry object formed of a composition of the invention.

In some embodiments, the amount of the waste material in a dry object manufactured from a composition is between 60 and 99 wt %. In some embodiments, the amount of the filler is between 60 and 99, 60 and 98, 60 and 97, 60 and 96, 60 and 95, 60 and 94, 60 and 93, 60 and 92, 60 and 91, 60 and 90, 70 and 99, 75 and 99, 80 and 99, 85 and 99, 90 and 99, 60 and 70, 60 and 80, 70 and 99, 70 and 98, 70 and 97, 70 and 96, 70 and 95, 70 and 90, 70 and 85, or between 70 and 80 wt %.

In some embodiments, the amount of the waste material in a dry object manufactured from a composition of the invention is between 60 and 99, or between 60 and 80, or between 70 and 99, or between 70 and 80 wt %.

As noted hereinabove, the wood waste may comprise accidental, random and unselected contaminants such as various adhesives, various polymeric materials, pigments, solvents, solubilizing agents and others. Non-limiting examples of contaminants include adhesives, PVC, epoxy, PVA, formaldehyde, isocyanates and others. The maximum amount of such contaminants is 1 wt % or up to 10 wt %.

In some configurations, compositions and products of the invention exclude adhesives, polymeric materials, pigments, solvents, solubilizing agents and others which are not natural, and further or alternatively exclude adhesives, PVC, epoxy, PVA, formaldehyde, isocyanates and others.

Alternatively or additionally, the filler is an inorganic filler. While the inorganic material is a natural material, it need not be provided from a plant source. The inorganic material is typically free of carbon or contains small amounts of carbonaceous materials. Non-limiting examples of such inorganic materials include calcium carbonate, charcoal, clay, chalk, Kaolin, silica, natural metal silicates, metal oxides and ceramic minerals. The addition of the inorganic fillers allows an increase in the density as well as tailoring of different appearances and physical properties. The metal oxide may be an additive of choice, in some cases.

In some embodiments, the filler may comprise a combination of two or more fillers, as defined and selected herein, each being of the same or different type. For example, where the filler is a wood-based filler it may comprise two or more wood fillers from different sources. Or, where the filler is a wood filler it may be provided in combination with an inorganic filler as disclosed. Any combination of any of fillers defined and disclosed herein is within the scope of compositions and products of the invention.

The at least one natural binder is a material that is capable of adhesively associating components of the composition into a single continuous, homogenous and monolithic form. The binder is not a synthetic adhesive. Typically, the binder is a gum, a polymeric material, an inorganic material or a biomaterial (i.e., having a biological function in a living plant or animal), which creates chemical association of functionalities present on the wood particles and the binder material. Without wishing to be bound by theory, such associations provide strong interactions due to formation of covalent and/or ionic bonds or other chemical associations between the wood particles and the binder material. These functionalities may vary, and may involve carboxylic acids, hydroxyl groups and others. The interactions may be responsible to the superior processing (flow) capabilities and the high mechanical and unique physical properties (fire retardancy and preventing water absorption) handoff products derived from the compositions.

The amount of a binder in a composition of the invention may vary depending on the binder used and/or on the components making up the composition. Typically, the amount of a binder in a composition of the invention is at least 2 wt %. In some embodiments, the amount of the binder does not exceed 30 wt %.

In some embodiments, the amount of a binder in a composition of the invention is between 2 and 30 wt %. In some embodiments, the amount of a binder in a composition is between 2 and 30, 5 and 30, 10 and 30, 15 and 30, 20 and 30, 2 and 25, 2 and 20, 2 and 15, 2 and 10, 2 and 5, 5 and 30, 5 and 25, 5 and 20, 5 and 15, 5 and 10, 10 and 30, 10 and 25, or between 10 and 20 wt %.

In some embodiments, the amount of a binder in a dry object made of a composition of the invention is between 5 and 50 wt %. In some embodiments, the amount of a binder in an object formed of a composition is between 5 and 50, 5 and 45, 5 and 40, 5 and 35, 5 and 30, 5 and 25, 5 and 20, 5 and 15, 5 and 10, 10 and 50, 10 and 45, 10 and 40, 10 and 35, 10 and 30, 10 and 25, 10 and 20, 10 and 15, 20 and 50, 25 and 45, 30 and 50, 40 and 50, or between 25 and 50 wt %.

The binder may be a gum, a polymeric material, an inorganic material or a biomaterial.

In some embodiments, the binder according to the invention is, comprises, or consists, or includes microcrystalline cellulose (MCC), carboxymethyl cellulose (CMC), starch, xanthan gum, guar gum, arabic gum, grain-based binders, lignin and lignin derivatives, cinnamon powder, transglutaminase, zinc oxide, slacked lime, sodium hydroxide, borax, protein-based binders and gluten powder.

In some embodiments, the binder according to the invention is, comprises, or consists, or includes starch, xanthan gum, guar gum, arabic gum, lignin, cinnamon powder, transglutaminase, zinc oxide, slacked lime, sodium hydroxide, borax, protein-based binders or gluten powder.

In some embodiments, the binder according to the invention is, comprises or consists, or includes a biomaterial such as a protein, a carbohydrate, a sugar, a biopolymer, a fibrous material and others.

In some embodiments, the binder according to the invention is, comprises or consists, or includes a protein. Thus, the binder may be regarded a protein-based binder.

In some embodiments, the binder is a protein-based binder selected amongst plant-based proteins such as soy-based proteins, corn-based proteins, wheat-based proteins, guar proteins, legume-based proteins, pea-based proteins and barley-based protein products.

In some embodiments, the protein-based protein is selected amongst animal-based protein.

In some embodiments, a composition of the invention comprises at least one filler, as defined herein, at least one protein-based binder and water.

In some embodiments, a composition consisting water, at least one filler and at least one binder, being optionally but not necessarily a protein-based binder, each as defined herein.

In some embodiments, a composition consisting a liquid medium such as water, at least one filler and at least one binder, being optionally but not necessarily a protein-based binder, each as defined herein.

Each of the fillers and binders constitute separate and independent embodiments of the invention.

In some embodiments, a composition of the invention comprises at least one plant-based filler and at least one protein-based binder.

In some embodiments, a composition of the invention consisting at least one plant-based filler and at least one protein-based binder and optionally at least one liquid medium such as water.

In some embodiments, the protein-based binder is a protein selected from actin, collagen, dystrophin, elastin, fibrin, keratin, myosin, nebulin, pikachurin, titin, tropomyosin, tubulin, casein, ferritin, gliadin, kafirin, oryzin, zein, whey protein and others. Each of the aforementioned proteins constitutes a separate and independent embodiment. Thus, the protein may be any one or more of actin, collagen, dystrophin, elastin, fibrin, keratin, myosin, nebulin, pikachurin, titin, tropomyosin, tubulin, casein, ferritin, gliadin, kafirin, oryzin, zein, whey protein and others.

In some embodiments, the protein-based binder is derived from eggs, milk and milk products, nuts, legumes and beans.

In some embodiments, the protein-based binder is derived from milk and milk products, nuts, legumes and beans.

In some embodiments, the protein-based binder is derived from milk and milk products or from nuts or from legumes and beans.

In some embodiments, the protein-based binders are milk proteins or soy proteins.

In some embodiments, a composition of the invention comprises at least one filler, as defined herein, and at least one protein-based binder selected from milk-derived proteins.

In some embodiments, a composition of the invention comprises at least one filler, as defined, and at least one protein selected from actin, collagen, dystrophin, elastin, fibrin, keratin, myosin, nebulin, pikachurin, titin, tropomyosin, tubulin, casein, ferritin, gliadin, kafirin, oryzin, zein, and whey protein.

In some embodiments, a composition of the invention consists at least one filler, as defined, and at least one protein selected from actin, collagen, dystrophin, elastin, fibrin, keratin, myosin, nebulin, pikachurin, titin, tropomyosin, tubulin, casein, ferritin, gliadin, kafirin, oryzin, zein, and whey protein; and water.

In some embodiments, a composition of the invention comprises at least one filler, as defined, and at least one protein selected from actin, collagen, dystrophin, elastin, fibrin, keratin, myosin, nebulin, pikachurin, and titin.

In some embodiments, a composition of the invention consists at least one filler, as defined, and at least one protein selected from actin, collagen, dystrophin, elastin, fibrin, keratin, myosin, nebulin, pikachurin, and titin; and water.

In some embodiments, a composition of the invention comprises at least one filler, as defined, and at least one protein selected from tropomyosin, tubulin, casein, ferritin, gliadin, kafirin, oryzin, zein, and whey protein.

In some embodiments, a composition of the invention consists at least one filler, as defined, and at least one protein selected from tropomyosin, tubulin, casein, ferritin, gliadin, kafirin, oryzin, zein, and whey protein; and water.

In some embodiments, a composition of the invention comprises at least one filler, as defined, and at least one protein selected from casein, ferritin, gliadin, kafirin, oryzin, and zein.

In some embodiments, a composition of the invention consists at least one filler, as defined, and at least one protein selected from casein, ferritin, gliadin, kafirin, oryzin, and zein; and water.

In some embodiments, a composition of the invention comprises at least one filler, as defined, and at least one protein selected from casein, ferritin, and gliadin.

In some embodiments, a composition of the invention comprises at least one filler, as defined, and casein or ferritin or gliadin.

In some embodiments, a composition of the invention consists at least one filler, as defined, and casein or ferritin or gliadin; and water.

In some embodiments, each of the aforementioned binders, e.g., casein or ferritin or gliadin, or the others, may be presented in a salt form, wherein the salt is a monovalent or divalent salt derived from a monovalent or divalent cation such as sodium, lithium, potassium, calcium, zinc and others.

In some embodiments, the protein-based binder is different from a plant-derived protein, i.e., is selected amongst animal-derived proteins.

In some embodiments, the animal-derived protein may be a whey protein, a hydrolyzed whey protein, a milk protein, a casein protein, a hydrolyzed casein protein, an egg protein, a hydrolyzed egg protein, a collagen protein, a hydrolyzed collagen protein, keratin, and others.

In some embodiments, the animal-derived protein is a milk protein, a casein protein, a hydrolyzed casein protein, an egg protein, a hydrolyzed egg protein, a collagen protein, or a hydrolyzed collagen protein.

In some embodiments, the animal-derived protein is a milk protein, a casein protein, or a collagen protein.

In some embodiments, the animal-derived protein is casein or a collagen.

In some embodiments, the animal-based protein is a hydrolyzed collagen such as gelatin.

Any of the binders disclosed herein and used in accordance with the invention may be used in their natural form, in their ionic form (namely as salt forms), as derivatized forms (e.g., as substituted acid or base forms), or in any other form suitable for achieving their stated purpose.

The amount of the binder in compositions of the invention may vary. Typically, the binder, e.g., at least one protein-based binder or protein, may be between 1 and 15% w/w. In some embodiments, the amount of the binder is between 1 and 15, 1 and 14, 1 and 13, 1 and 12, 1 and 11, 1 and 10, 1 and 9, 1 and 8, 1 and 7, 1 and 6, 1 and 5, 2 and 15, 2 and 14, 2 and 13, 2 and 12, 2 and 10, 2 and 9, or between 2 and 8 wt %.

The invention further provides a composition comprising or consisting casein and at least one wood filler, as disclosed herein. In some embodiments, the composition comprises water.

Further provided is a composition comprising or consisting collagen or hydrolyzed collagen and at least one wood filler. In some embodiments, the composition comprises water. In some embodiments, the hydrolyzed collagen is gelatin.

Further provided is a composition consisting casein, at least one wood filler and optionally a liquid carrier.

Also provided is a composition consisting collagen or hydrolyzed collagen (such as gelatin), at least one wood filler and optionally at least one liquid carrier.

Apart from the filler and binder, for some applications, the composition may further comprise a selection of additives. These may be functional or active additives or inactive additives. The active additives may be selected from surfactants, crosslinking agents, antifungal agents, antioxidants, protective agents and others. The inactive agents may be selected from pigments, oils, lubricants, fragrant materials, and others.

In some embodiments, the additive is a crosslinking agent. The crosslinking agent may be used to achieve solidification of the product by increasing crosslinking between functionalities present on components of the composition. For example, chemical bonding may be achieved between metal ion and OH groups or between any other functionalities. Without wishing to be bound by mechanistic description, bonding may be via ionic bonding or covalent bonding.

The amount of any additive in a composition of the invention depends on the type of additive, the function it is intended to achieve and on any other parameter as known to the practitioner. Typically, the amount of the additive should not exceed 10 wt %. The amount may thus be 1, 2, 3, 4, 5, 6, 7, 8, 9, or 10 wt % in a composition of the invention.

The amount of the additive in a final dry object made from a composition of the invention should also be kept to the bare minimum. In the dry object, and depending on the amount used in a composition from which the object is formed, the amount of the additive will be between 2 and 15 wt %. the amount may be between 2 and 15, 2 and 10, 2 and 5, 5 and 15, 5 and 10 or 3 and 8 wt %.

Crosslinking may be achieved spontaneously, thermally, by exposure to light or a light source of a particular wavelength, by radical polymerization or by any combination thereof. Thus, crosslinking agents may vary. Non-limiting examples include boric acid and derivatives thereof, tartaric acid and derivatives thereof, citric acid and derivatives thereof, tannic acid and derivatives thereof, acetic acid and derivatives thereof, phosphoric acid and derivatives thereof, sulfuric acid and derivatives thereof, calcium chloride, calcium hydroxide, calcium oxide, magnesium oxide, aluminum oxide, aluminum sulfate, iron oxide, copper oxide, copper hydroxide, sodium hydroxide, lignin and derivatives thereof, and magnesium hydroxide.

In some embodiments, a crosslinking agent is not present in a composition of the invention. Where present, the amount of the crosslinking agent in a composition of the invention should be maintained as low as possible. Typically, the mount does not exceed 5 wt % of the total weight of the composition.

In some embodiments, the amount of the crosslinking agent is between 1 and 5 wt %. In some embodiments, the amount is 1, 2, 3, 4, or 5 wt %.

In some embodiments, the additive is an antifungal agent used for preventing fungal growth over time or for irradicating fungi in fungal-contaminated wood or waste components. The antifungal agent may be selected from sodium benzoate, calcium propionate, potassium sorbate, zinc oxide, boric acid and derivatives thereof, cinnamon, basil, oregano, ginger, clove, thyme, lemon grass, eucalyptus leaves, rosemary and star anise. All the herbal additives can be incorporated in powder form or their equivalent essential oils.

Natural pigments can also be added for color alteration. Natural pigments and colorants include organic and inorganic materials such as indigo powder, red alkanet root, turmeric, sumac, paprika, lignin and its derivatives, natural metal oxides powders, dried beet powder and others.

Typically, compositions of the invention are configured and thus suitable for manufacture of wood products by molding or by any other shaping techniques.

As known in the art, molding involves shaping a malleable raw material by using a fixed frame or a mold. The mold is generally a hollow cavity receptacle, which may be made of a variety of materials such as metal, ceramic, polymeric or glass, and which its shape is derived from the initial pattern or template of the final desired object.

Moreover, compositions of the invention can be formed by 3D printing or by methods comprising or consisting molding, extrusion, 3D printed press-injection molding onto various shapes and geometries. The extrusion can be one or twin-screw extruder with or without heating and with a special nozzle in the final desired shape. Hydraulic press can be used in various pressures onto the material inside a breathable or sealed mold that can be heated, cooled down or treated under vacuum and/or air pressure. Injection molding can be used to fill the material into intended molds.

In most general terms, a process for manufacturing a wood-based object according to the invention comprises introducing a composition into a mold cavity, and permitting said composition to dry to provide the object, such that the shape and size of the object is determined by the size and shape of the mold cavity. Molding techniques are within those known to a person of skill in the art.

In some embodiments, the composition is allowed to fill the mold cavity, e.g., by compacting or pressing the composition into the mold cavity.

In some embodiments, the process further comprises obtaining a composition of the invention. In some embodiments, the composition is formed by mixing the components thereof under conditions forming a homogenous mixture. In some embodiments, the components are mixed utilizing a mixing tool selected from Planetary mixer, kneading machine, sigma mixer, dual-axis centrifugal mixer, spiral mixer, convective mixer, homogenizer, overhead stirrer, chemical reactor, mortar and pestle, extruder.

In some embodiments, the mixing comprises powder mixing of components of the composition, without water, to obtain a dry blend. Thus, compositions of the invention may be in a form of a dry blend or containing water. To obtain a water-based composition, a dry blend is mixed with water, e.g., at times manually and vigorously, until full homogeneity and good mechanical strength is achieved. In some cases, the binder, as defined and selected, may be in a liquid form. In such cases water may not be needed. The amount of water in compositions of the invention may thus range between 0 and 30 wt %.

In some embodiments, the process thus comprises:
obtaining a composition of the invention;
introducing the composition into a mold and allowing said composition to fill said mold, and
permitting said composition to dry to provide the object.

In some embodiments, while in the mold, the composition is pressed or thermally treated or treated under vacuum.

In some embodiments, the composition is introduced into the mold by extrusion, e.g., utilizing a one or twin-screw extruder with or without heating. This may include dies which are static or changeable during extrusion.

In some embodiments, 3D printing of the material could be used to produce the final shape.

In some embodiments, injection molding is used to introduce the composition into the mold.

In some embodiments, a dispenser is used to introduce the composition into the mold.

In some embodiments, drying may be achieved at ambient (at room temperature, 23-35° C.). In some embodiments, drying may be achievable exposing the composition, while in the mold, to various environmental conditions, such as dried/humid and hot/cold conditions and/or with different radiation sources such as thermal radiation, convection heating, microwave radiation, infra-red radiation and others.

The invention further provides a wood object formed of a composition of the invention.

The invention further provides a wood object manufactured according to processes of the invention.

The invention further provides a wood object formed of a composition of the invention, employing a process according to the invention.

The wood objects are typically “dry objects”, namely objects that are essentially water free or free of any fluid. Such exclusion of water or solvents from the wood object allows for superior mechanical properties as disclosed herein. The term “dry” refers to an object that its water content is between 0 and 10 wt %. In other words, an object that is absolutely free of water or an object that comprises entrapped water or water of hydration that cannot be removed, such water may constitute no more than 10 wt %. In some embodiments, the water content of a dry object is 0, 1, 2, 3, 4, 5, 6, 7, 8, 9 or 10 wt %.

The wood objects of the invention may be characterized as having the following mechanical properties:
strength>15 MPa,
Impact>2 kJ/m2, or above 3 kJ/m2, as exemplified in the table below:

| | Max Flexural | Impact |
|---|---|---|
| Material | Strength (MPa) | Strength (KJ/M²) |
| Municipal waste filler | 30.7 ± 1.0 | N/A |
| Standard | | |
| Pine filler Standard | 40.6 ± 4.7 | 3.62 ± 1.07 |
| according to the present | | |
| invention | | |
| Pine filler Premium | 37.8 ± 2.6 | 3.58 ± 0.96 |
| according to the invention | | |

water resistance similar/superior to those of MDF, e.g., while both laminated MDF and non-laminated MDF demonstrated water absorbance of over 130% (w/w), water absorbance demonstrated by products of the invention were between 107 and 124% (w/w). See exemplified data in the table below:

| | | | Water |
|---|---|---|---|
| | Water | Water | absorption % |
| | absorption % | absorption % | W/W After |
| | W/W After 2 h | W/W After 24 h | reconditioning |
| Unlaminated MDF | >110% | 130.2% | N/A |
| Laminated MDF | >120% | 134.4% | N/A |
| Premium product | 107.6% | 124.1% | 105.5% |
| according to the | | | |
| invention | | | |

Surface hardness above 60 D, comparison of different materials to materials of the invention is provided in the table below:

| Material | Hardness Shore D |
|---|---|
| Unlaminated MDF | 68.17 ± 2.0 |
| Pine filler Standard | 64.8 ± 3.7 |
| according to the invention | |
| Pine filler Premium | 73.5 ± 1.0 |
| according to the invention | |
| Pine wood | 44.0 ± 3.1 |
| Polypropylene | 62.8 ± 1.5 |
| Industrial Bamboo | 57.3 ± 0.8 |

fire retardant properties (without adding brominated-based FR), results exemplified below:
   Test Method CS/JAR/FAR 25.853—Ignition Vertical test
   Samples dimensions—300×100 mm×3 samples

| Batch | Description | 12 sec | 60 sec |
|---|---|---|---|
| DW- | Municipal waste filler | 0 sec, 5 mm, | 0 sec, 18.3 mm, |
| 811221 | Standard according to | No drip | No drip |
| | the invention | | |
| DW- | Municipal waste filler | 0 sec, 5 mm, | 0 sec, 15 mm, |
| 841221 | Premium according to | No drip | No drip |
| | the invention | | |
| DW- | Pine filler standard | 0 sec, 5 mm, | 0 sec, 30 mm, |
| 101221 | according to the | No drip | No drip |
| | invention | | |

can be polished as natural wood,
can be drilled and nailed into.

In some embodiments, the object can contain inserts (embedded during molding or over molding together with the object) from different materials (metal/plastic/ceramics/magnetic materials) for further usage of the object (such as installation\hanging).

Objects of the invention may be of any size and shape. They may be tailored as construction elements, as decorative objects, as building blocks for a variety of assemblies etc. As the composition is sufficiently flowable to meet any mold shape and flow into any crevasse in an irregularly shaped mold, the technology is uniquely capable of providing out of plane products which are otherwise difficult to manufacture as well as planer or regularly shaped objects. These objects may be decks, flooring, panels, homeware objects, toys, kitchenware, garden ware, decorative objects and others.

The object may be used as is or may be further treated to endow further visual, mechanical and other properties. After the object has been dried, it may be post processed by conventional methods into a final product. The post-treatment methods may include sanding, polishing, sawing, gluing, surface chemical modification (via e.g., crosslinking), laser engraving and cutting, heat embossing and engraving, mechanical engraving, milling and others. In order to achieve water resistance and different surface smoothness and glossiness, the object outer surface may be treated with a finishing material such as oil based coatings-drying oils (linseed oil, tung oil), mineral oil, canola oil, castor oil, argan oil, beeswax, soy wax and combinations thereof: solvent based coatings, acetone, with or without zein, shellac, beeswax, soy wax, linseed oil, mineral oil, tung oil or water-based coatings, glycerol, protein (as defined herein for protein-based binders), triglycerides, monoglycerides, diglycerides, GMS (glyceryl monostearate), glyceryl citrate, cetyl alcohol, Citrate 20, Tween 80 (sodium polysorbate), fatty acids (such as stearic, oleic, lauric, capric, palmitic, linolenic acid and their derivatives), lecithin, MCC (micro-crystalline cellulose).

Additional crosslinking solutions could be applied onto the surface to increase the water resistance. These include for example citric acid, tartaric acid, adipic acid, boric acid, acetic acid, phosphoric acid, hypophosphorous acid and their derivatives: calcium hydroxide, calcium chloride, magnesium hydroxide, copper hydroxide or their metal oxides.

In some embodiments, the object formed of compositions of the invention is a toolholder. Toolholders are add-on members typically associated with small objects intended for presentation or sale. The toolholders, typically made from polymeric materials, are disposable objects which have no use after the object has been sold or otherwise after detached from the object. Typical toolholders may have a flat region which is used to present product information and price and typically also means, such as a puncture or hole, for hanging the product in a presentation rack. Each toolholder may vary in size and shape. On average, a plastic toolholder may weight anywhere 3 and 10 grams. As the vast majority of the tool holders are associated to a single object, some may be associated to several or series or sets of objects, the amount of plastic or other polymeric materials discarded each year is huge, presenting yet another source of environmental pollutant.

An exemplary toolholder used according to the state of the art is exemplified in FIG. 1.

The toolholder of the invention, based on compositions and blends of the invention, is an environmentally friendly, biodegradable, single piece breakable toolholder that is fully recyclable, that is light weight, cheaper to produce and which removed many of the environmental risks associated with discarded plastic. As with known toolholders, toolholders of the invention may be tailored for use as tag placement elements, but can also be used as protective elements providing mechanical and thermal damage protection to sensitive parts or tools.

As demonstrated herein, a toolholder of the invention is a single piece element formed to tightly hold a tool, as defined herein, through at least one surface region thereof. The tool holder is not in a form of a packaging element or a container which contains or holds the tool within a cavity thereof. In some configurations, the toolholder is reversibly associated with a surface region of the tool such that it may be clearly presented for sale and easily released from the tool prior to use.

Thus, in another of its aspects, there is provided a toolholder configured to securely and reversibly associate to a surface region of a tool, wherein the toolholder is formed of a natural composition of the invention, as disclosed herein, or from a cellulose-based composition, as defined herein.

The invention further provides a tool provided with a securely associated toolholder, the association allowing for detaching the toolholder from the tool, thereby enabling use of the tool, wherein the tool holder is formed of a material composition, as defined herein.

Further contemplated is a tool kit, the kit comprising a tool reversibly associated with a toolholder, the toolholder being formed of a material composition, as defined herein.

As used herein, the term “toolholder” refers to an element that can be safely attached or fixed to a tool to be presented for sale and which can be detached from the tool prior to first use. Toolholders of the invention comprise a surface which may be shaped as desired and which may comprise an embedded fracture line or fracture surface, sometimes a visible fracture line, defining a breaking line, allowing for facile breaking (by hand, not requiring any tools) of the toolholder and release of the tool. The surface may be provided with a cavity or a member through which the toolholder is associated with the tool, the cavity or member being typically a holding member structure configured to tightly hold a surface region of the tool. The surface of the toolholder may also be configured and sized to provide information regarding the tool, price, identity of manufacturer, etc. For presentation, the surface of the toolholder may also be provided with a hole for hanging the toolholder-tool pair for presentation or sale.

The toolholder of the invention may be formed to fixedly associate with a region of the tool, optionally by engulfing said region for tight association. The association is by no means chemical. It may involve association by pressure, achievable by e.g., press molding. The engulfment around the region of the tool, while optionally being achievable by application of pressure, may involve thermal or pressure induced chemical and/or mechanical changes in the material composition making up the toolholder. In some configurations, the toolholder is configured not only to fixedly associate with a region of the tool for the purpose of presentation or sale, but also to protect certain regions or parts or elements of the tool from any damage.

The toolholder is typically not transparent and may thus be used to protect light or heat sensitive regions of the tool from exposure to light or heat.

The toolholder may be formed of a composite or a blend of materials. Generally speaking, the toolholder may be formed from a composition of wood fillers and natural binders, as disclosed herein, that are processed to provide a solid toolholder of a desired shape, size, texture, color and specific mechanical or chemical attributes.

Thus, the invention further provides a toolholder configured to securely and reversibly associate to a surface region of a tool, wherein the toolholder is formed of a material composition comprising naturally derived materials, as disclosed herein.

In some embodiments, the naturally derived materials are selected amounts wood fillers and natural binders, as disclosed herein.

In some embodiments, a toolholder according to the invention is formed of a material composition which comprises wood fillers and natural binders.

As disclosed hereinabove, the at least one “wood filler” is typically a powder obtained from ground tree material, ground dried leaves, ground natural wood waste, or cellulose-containing waste, including pulp, paper products (paper, cardboard, etc) or contaminated wood materials, such as MDF, OSB or furniture derived powder. The powder may comprise ground material from a single source or a variety of sources. Independent of the source of the filler, the powder is provided as particles having a size ranging from 1 μm to 1 cm.

The ground material may be derived from any part of a tree or a bush, including stalks or branches, trunk or wood bark and leaves. The trees or bushes may be selected from those referred to as hard or soft wood trees or bushes.

In some embodiments, the trees or bushes are selected from ash, basswood, beech, birch, eucalyptus, walnut, pecan, cedar, cherry, elm, gum, hickory, lauan, mahogany, maple, oak, pine, poplar, redwood, rosewood, satinwood, sycamore, teak, alder, apple, aspen, chestnut, cottonwood, cypress, fir, hackberry, hemlock, holly, koa, laurel, locust, magnolia, pear-wood, spruce, tupelo and willow.

In some cases, the ground material is ground dried leaves which may be naturally dry fallen leaves or leaves purposely dried. The leaves may be of any tree or bush as selected above.

As further disclosed herein, the “natural binder” used may be any material capable of adhesively associating components of the composition into a single continuous, homogenous and monolithic form. Typically, the binder is a gum, a polymeric material or an inorganic material.

Non-limiting examples of binders according to the invention include microcrystalline cellulose (MCC), carboxymethyl cellulose (CMC), starch, xanthan gum, guar gum, arabic gum, grain-based binders, lignin and lignin derivatives, cinnamon powder, transglutaminase, zinc oxide, slacked lime, sodium hydroxide, sodium bicarbonate, sodium carbonate, borax, protein-based binders and gluten powder.

In some embodiments, the protein-based binder is a protein derived from lean meats, poultry, fish and seafood, eggs, milk and milk products, nuts, legumes and beans and others.

In some embodiments, the protein-based binder is a protein selected from actin, collagen, dystrophin, elastin, fibrin, keratin, myosin, nebulin, pikachurin, titin, tropomyosin, tubulin, casein, ferritin, gliadin, kafirin, oryzin, zein, whey protein and others. Each of the aforementioned proteins constitutes a separate and independent embodiment. Thus, the protein may be any one or more of actin, collagen, dystrophin, elastin, fibrin, keratin, myosin, nebulin, pikachurin, titin, tropomyosin, tubulin, casein, ferritin, gliadin, kafirin, oryzin, zein, whey protein and others.

In some embodiments, the protein-based protein is derived from eggs, milk and milk products, nuts, legumes and beans.

In some embodiments, the protein-based protein is derived from milk and milk products, nuts, legumes and beans.

In some embodiments, the protein-based protein is derived from milk and milk products or from nuts or from legumes and beans.

In some embodiments, the protein-based binders are milk proteins and soy proteins.

In some embodiments, a composition consisting water, at least one filler and at least one binder, each as defined herein.

In some embodiments, a composition consisting a liquid medium such as water, at least one filler and at least one binder, each as defined herein.

Each of the fillers and binders constitute separate and independent embodiments of the invention.

In some embodiments, a composition of the invention comprises at least one plant-based filler and at least one protein-based binder.

In some embodiments, a composition of the invention consisting at least one plant-based filler and at least one protein-based binder and optionally at least one liquid medium such as water.

In some embodiments, the protein-based binder is different from a plant-derived protein, i.e., is selected amongst animal-derived proteins.

In some embodiments, the animal derived protein may be a whey protein, a hydrolyzed whey protein, a milk protein, a casein protein, a hydrolyzed casein protein, an egg protein, a hydrolyzed egg protein, a collagen protein, a hydrolyzed collagen protein, keratin, and others.

In some embodiments, the animal derived protein is a milk protein, a casein protein, a hydrolyzed casein protein, an egg protein, a hydrolyzed egg protein, a collagen protein, or a hydrolyzed collagen protein.

In some embodiments, the animal-derived protein is a milk protein, a casein protein, or a collagen protein.

In some embodiments, is casein or a collagen.

In some embodiments, the animal-based protein is a hydrolyzed collagen such as gelatin.

Any of the binders disclosed herein and used in accordance with the invention may be used in their natural form, in their ionic form (namely as salt forms), as derivatized forms (e.g., as substituted acid or base forms), or in any other form suitable for achieving their stated purpose.

Apart from the wood filler and natural binder, for some applications, the blend from which the toolholder is formed may further comprise a selection of additives. These may be functional or active additives or inactive additives. The active additives may be selected from surfactants, crosslinking agents, antifungal agents, antioxidants, protective agents and others. The inactive agents may be selected from pigments, oils, lubricants fragrant materials, and others.

In some embodiments, the additive is a crosslinking agent. The crosslinking agent may be used to achieve solidification of the product by increasing crosslinking between functionalities present on components of the composition. For example, chemical bonding may be achieved between metal ion such as Ca and Mg, and OH groups or between any other functionalities. Without wishing to be bound by mechanistic description, bonding may be via ionic bonding or covalent bonding.

Crosslinking may be achieved spontaneously, thermally, by exposure to light or a light source of a particular wavelength, by radical polymerization or by any combination thereof. Thus, crosslinking agents may vary. Non-limiting examples include boric acid and derivatives thereof, tartaric acid and derivatives thereof, citric acid and derivatives thereof, tannic acid and derivatives thereof, acetic acid and derivatives thereof, phosphoric acid and derivatives thereof, sulfuric acid and derivatives thereof, calcium chloride, calcium hydroxide, calcium oxide, magnesium oxide, aluminum oxide, iron oxide, copper oxide, copper hydroxide, sodium hydroxide, lignin and derivatives thereof, and magnesium hydroxide.

In some embodiments, the additive is an antifungal agent for use in preventing fungal growth over time or for irradicating fungi in fungal-contaminated wood or waste components. The antifungal agent may be selected from sodium benzoate, calcium propionate, potassium sorbate, zinc oxide, boric acid and derivatives thereof, cinnamon, basil, oregano, ginger, clove, thyme, lemon grass, eucalyptus leaves, rosemary and star anise. All the herbal additives can be incorporated in powder form or in their equivalent essential oils.

Natural pigments can also be added for color alteration. Natural pigments and colorants include organic and inorganic materials such as indigo powder, red alkanet root, turmeric, sumac, paprika, lignin and its derivatives, natural metal oxides powders, dried beet powder and others.

In some embodiments, the wood filler is provided in a form of a particulate matter. In some embodiments, the particulate matter is of a particle size (average diameter) ranging between 200 and 500 μm.

In some embodiments, the toolholder may be formed of a blend comprising ground powder of Pine Tree or Municipal waste wood (the ground powder being a particulate powder with particles having an average diameter as defined or of about 400 μm) and a mixture of natural binders such as crystalline nano or micro cellulose, starch, protein-based binders such as milk protein and derivatives thereof, wheat flour protein and derivatives thereof or soy protein isolate and derivatives thereof.

In some embodiments, other or additional binders may be present, these include carboxymethyl cellulose (CMC).

In some embodiments, other or additional inorganic additives may be present, these include zinc oxide, borax, calcium carbonate, carbonate salts, e.g., sodium carbonate or sodium bicarbonate, calcium hydroxide, sodium hydroxide and magnesium hydroxide.

The invention further provides a toolholder, as defined, formed of a cellulose-based composition. In some embodiments, the cellulose-based composition may comprise water, at least one wood material or wood filler, as defined herein, optionally selected from wood flour, wood chop, micro-crystalline cellulose (CMC) and wood chips, and at least one cellulose nanomaterial, optionally selected from cellulose nanocrystals (CNC), nanofibrillated cellulose (NFC), and bacterial nanocellulose (BNC).

In some embodiments, the cellulose-based composition comprises between 50 and 99 wt % of a cellulose material, as selected herein.

In some embodiments, the amount of the cellulose material, being one or more of e.g., micro-crystalline cellulose (CMC) and wood chips, and at least one cellulose nanomaterial, optionally selected from cellulose nanocrystals (CNC), nanofibrillated cellulose (NFC), and bacterial nanocellulose (BNC), may be between 50 and 99, 50 and 95, 50 and 90, 50 and 85, 50 and 80, 50 and 75, 50 and 70, 50 and 65, 50 and 60, 50 and 55, 60 and 95, 60 and 90, 60 and 80, 60 and 70, 70 and 90, 80 and 90, 70 and 95, 60 and 99 or 70 and 99 wt %.

The cellulose-based composition may be used in combination or alternatively to using the natural composition of the invention, as defined herein.

In some embodiments, in a composition of the invention for use in manufacturing an object such as a toolholder, the composition may comprise at least one nanocellulose, as selected herein.

In some embodiments, the nanocellulose is CNC.

The toolholder may be formed from any of the material compositions disclosed herein by shaping the malleable blend material in a fixed frame or a mold having an internal cavity of a desired shape, size and form and which is provided with the tool around which the toolholder is to be formed. The toolholder is formed by pressing an amount of the material blend within the mold and around a region of the tool, to thereby provide the tool tightly fixed within the molded toolholder. Thus, the invention further provides a provision of facile industrial process for making a toolholder according to the invention.

The mold is generally a hollow cavity receptacle, which may be made of a variety of materials such as metal, ceramic, polymeric or glass, and which its shape is derived from the initial pattern or template of the final desired toolholder.

The material blend used for forming the mold may be molded, extruded, pressed injection molded onto various shapes and geometries. The extrusion can be one or twin-screw extruder with or without heating and with a special nozzle in the final desired shape. Hydraulic press can be used in various pressures onto the material inside a breathable or sealed mold that can be heated, cooled down or treated under vacuum and/or air pressure. Injection molding can be used to fill the material into intended molds.

In most general terms, a process for manufacturing a toolholder according to the invention comprises introducing a material blend as defined herein into a mold and allowing said blend to fill said mold and permitting said blend to dry and provide the toolholder.

In some embodiments, the process further comprises obtaining the material blend. In some embodiments, the blend is formed by mixing the components thereof under conditions forming a homogenous mixture. In some embodiments, the components are mixed utilizing a mixing tool selected from Planetary mixer, kneading machine, sigma mixer, dual-axis centrifugal mixer, spiral mixer, convective mixer, homogenizer, overhead stirrer, chemical reactor, mortar and pestle, extruder.

In some embodiments, the mixing comprises powder mixing of components of the blend, without water, to obtain a dry blend. The dry blend may then be mixed with water, by any means, such as mechanical or manual mixing, until full homogeneity and a desired mechanical strength is achieved.

In some embodiments, the process thus comprises:
obtaining a material blend;
introducing the blend into a mold and allowing said blend to fill said mold, and permitting said blend to dry to provide the toolholder.

In some embodiments, the process comprises a step of placing a tool (prior to the insertion of the material blend) to be fixedly associated with a toolholder in the mold.

In some embodiments, while in the mold, the blend is pressed or thermally treated or treated under vacuum so as to fixedly associate to the tool.

In some embodiments, the blend is introduced into the mold by extrusion, e.g., utilizing a one or twin-screw extruder with or without heating. This may include dies which are static or changeable during extrusion.

In some embodiments, injection molding is used to introduce the blend into the mold.

In some embodiments, a dispenser is used to introduce the blend into the mold.

In some embodiments, drying may be achieved at ambient (at room temperature, 23-35° C.). In some embodiments, drying may be achievable by exposing the blend, while in the mold, to various environmental conditions, such as dried/humid and hot/cold conditions and/or with different radiation sources such as thermal radiation, convection heating, microwave radiation, infra-red radiation and others.

The “tool” associated with a toolholder according to the invention may be any commerciable object that can be used for performing a certain action. The tool may be a tool made from a metallic material, from a polymeric material or any other solid material. The tools may be selected amongst blades, knives, sickles, scythes, hatchets, axes, gouges, drill bits, screwdrivers, hammers, nuts and bolts, wrenches, rulers, glasses, sensors, molds, jigs, trowels, welders, soldering irons, rivet guns, nail guns, or glue guns.

The tool may be one or a plurality or a set of such tools which are packaged together or as a set and share a single tool holder according to the invention. Such a tool set is a drill bit set.

Compositions of the invention may further be used for manufacturing tool holders or replaceable parts of any mechanical tool. The tool holder may be a tool-handle designed to be used with any tool or may form an integral part of a tool. The tool handle or tool part may be attachable to the body of the tool by any mechanical means, including by pressure attachment, attachment by nails or screws, etc.

As used herein and throughout of the specification, reference to any amount expressed by a weight % amount (wt %) refers to an amount of the material relative to the total amount of the composition or the product to which is related. For example, a component present in a composition in an amount of 5 wt %, means that it is present in the composition in an amount that is 5 wt % relative to the total weight of the composition. Same is applicable to amounts expressed with regard to final products.

Also, total amounts of ingredients in compositions and products of the invention should amount to 100%.

Further as may be understood, any reference to “a” component of a composition or a product of the invention encompasses one or a plurality of such components. For example, any reference to “a binder” equally refers to “at least one binder”. Similarly, any reference to a combination, composition, blend, product, process etc which “comprises” one or more components or ingredients, equally encompasses “consisting” of the same one or more components or ingredients.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 depicts toolholders of the art. Shown are a polymeric or plastic toolholder that is structured to receive and hold a drill.

FIGS. 2A-D provide images of toolholders according to the invention, depicting a drill as an exemplary tool. FIG. 2A shows side by side images of a toolholder of the art comprising a plastic toolholder and a drill (left image), and a toolholder of the invention (right image). FIG. 2B depicts an exemplary mold used for manufacturing toolholders of certain type and structural profile. A drill is positioned in a cavity adapted to receive the tool to be associated with the holder. FIG. 2C depicts a complete mold and FIG. 2D shows a toolholder removed from the mold.

FIGS. 3A-B depict before and after toolholders detached from their respective tools by breaking the holders along preformed fracture lines.

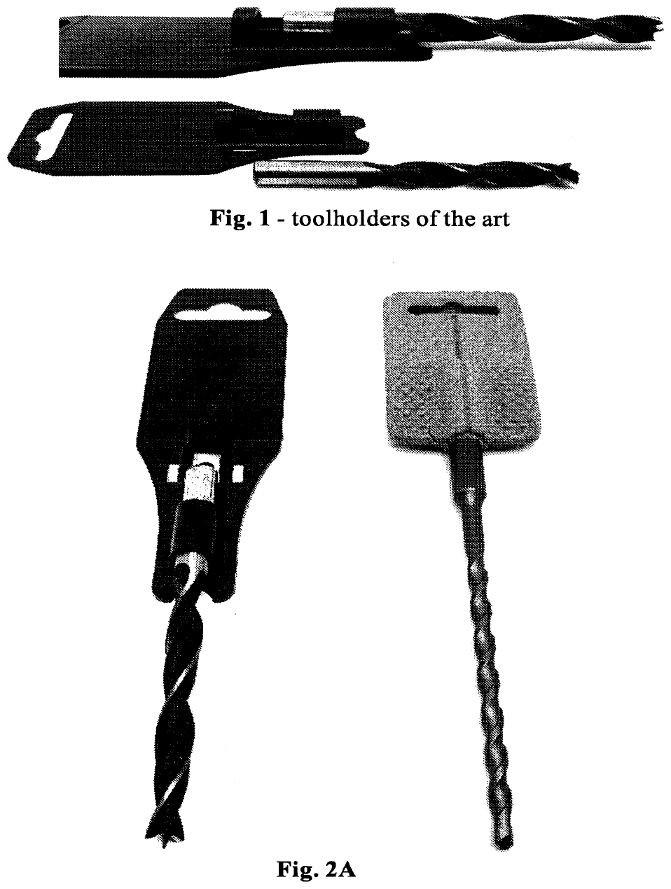

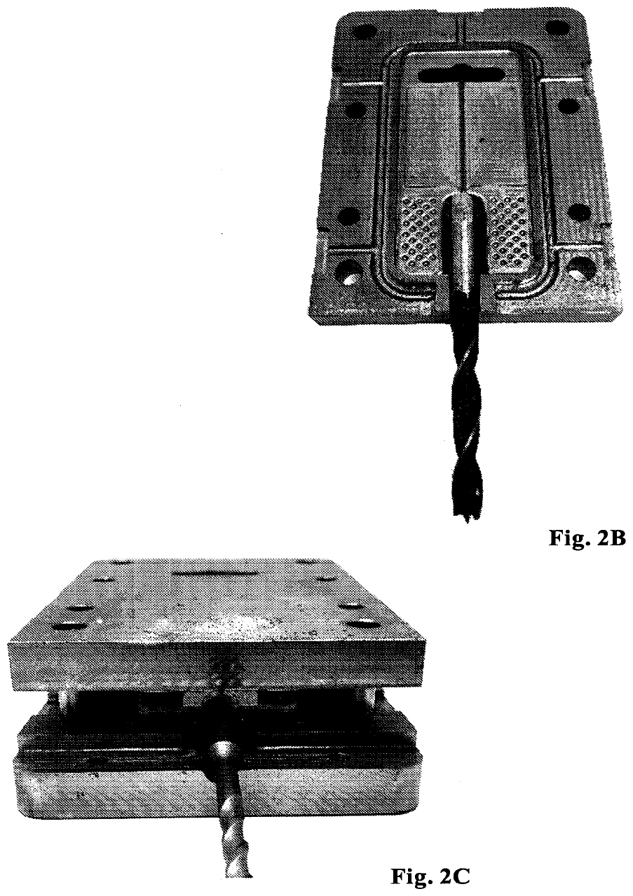

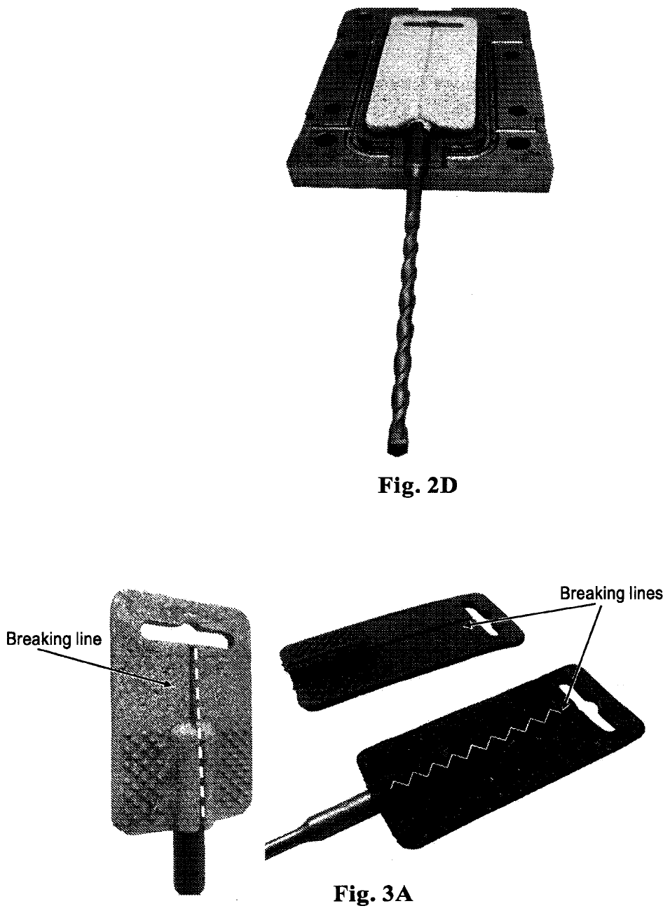

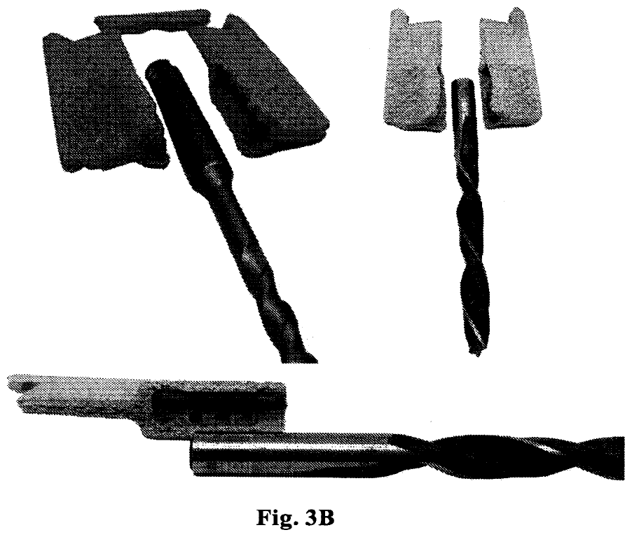

### DETAILED DESCRIPTION OF EMBODIMENTS

### Examples

### Example 1 (Reactor Preparation)—the First Stage is the Preparation of a Hydrogel of

1) natural binders such as crystalline nano cellulose and

2) a solvent such as water or glycerol (in excess) were mixed inside a reactor for 1-6 hours.

3) wood flour (Beech Tree with particle size of 75 μm-500 μm) was added to the formed hydrogel and then the combined formula was mixed inside the reactor (at 10-200 RPM) until full homogenization of the formula was achieved (between 30-120 min). Excess water was evaporated using a vacuum pump and an evaporation apparatus (the evaporation process took 1-12 hrs). The prepared formula was inserted into a mold and pressed using Hydraulic press (at 2500-20000 psi). Then the final shaped sample was removed from the mold and placed for drying at RT or various radiation sources (Infra-red, Thermal heating, microwave). After sample preparation, sanding/polishing was carried out and a wax coating was applied.

### Example 2 (Hydrogel & Wood Filler)—the First Stage is the Preparation of a Hydrogel of

1) natural binders such as crystalline nano cellulose and a solvent such as water or glycerol in a dual-axis centrifugal mixer for 2-30 mins.

2) the hydrogel achieved was added to wood flour (Beech Tree e.g., with particle size of 75 μm-500 μm) and the combine formula was mixed using a dual-axis centrifugal or planetary mixer for 2-30 mins. The mixed formula was then inserted into a mold and pressed using Hydraulic press (at 2500-20000 psi). Then the final shaped sample was removed from the mold and placed for drying at RT or various radiation sources (infra-red, thermal heating, microwave source). After the sample preparation, a post process of sanding/Polishing is made with wax coating as the final stage.

### Example 3

Where the water concentration used in Example 2 is lower than 45 wt %, the composition does not allow using an extruder and is dispensed directly into the mold. The resulting object is rigid and can hold its shape completely.

### Example 4 the First Stage is the Preparation of a Dry Blend Comprised from

1) a wood filler made from grounded powder of Beech Tree (particle size of 75 μm-500 μm), Municipal waste wood (particle size of 75 μm-1000 μm), Palm wood waste (particle size of 75 μm-1000 μm) with a binder mixture of natural binders such as

2) Crystalline Nano/Micro Cellulose (NCC/MCC), Starch, Pectin, Chitin, Agar Agar, Xanthan Gum, Guar Gum, Arabic Gum, Sorbitol, Natural latex, Carrageenan, Tannic acid (and its derivatives), Transglutaminase with protein-based binders such as milk protein (and its derivatives), Soy protein isolate and gluten powder (and its derivatives). Inorganic additives could be added such as Zinc oxide, Borax, Calcium hydroxide and other binders such as Carboxymethyl cellulose (CMC) were manually mixed until full homogenization. The dry blend was placed with a solvent such as Water, Ethanol or Glycerol in a dual-axis centrifugal or planetary mixer for 2-30 mins.

The material achieved putty-like properties and was inserted into a mold and pressed using hydraulic press (at 2500-20000 psi). Then the final shaped sample was removed from the mold and placed for drying at RT or various radiation sources (Infra-red, Thermal heating, microwave source). After the sample preparation, a post process of sanding/Polishing is made with wax coating as the final stage.

### Example 5 in which the Inorganic Additives are Added Upon Obtaining the Homogenous Mixture and Right Before Molding

### Example 6—the First Stage is the Preparation of a Dry Blend of

1) a wood filler made from for example: grounded powder of Beech Tree (particle size of 75 μm-500 μm), Municipal waste wood (particle size of 75 μm-1000 μm), Palm wood waste (particle size of 75 μm-1000 μm) with a mixture of natural binders such as Crystalline Nano/Micro Cellulose, Starch, Milk protein (and its derivatives) with a crosslinker of Calcium hydroxide were manually mixed until full homogenization. The dry blend was placed with a solvent such as Water or Glycerol in a dual-axis centrifugal or planetary mixer for 2-30 mins.

The material achieved putty-like properties and was inserted into a mold and pressed using Hydraulic press (at 2500-20000 psi). Then the final shaped sample was removed from the mold and placed for drying at RT or various radiation sources (Infra-red, Thermal heating, microwave source). After the sample preparation, a post process of sanding/Polishing is made with wax coating as the final stage.

### Example 7—the First Stage is the Preparation of a Dry Blend of

1) a wood filler made from grounded powder of Beech Tree (particle size of 75 μm-500 μm) with a mixture of natural binders such as Soy protein isolate and Gluten powder was manually mixed until full homogenization. The dry blend was placed with a solvent such as Water and/or Glycerol in a sigma blade extruder or kneader for 2-30 mins.

The material achieved putty-like properties and was inserted into a mold and pressed using Hydraulic press (at 2500-20000 psi). Then the final shaped sample was removed from the mold and placed for drying at RT or various radiation sources (Infra-red, Thermal heating, microwave source). After the sample preparation, a post process of sanding/Polishing is made with wax coating as the final stage.

### Example 8—the First Stage is the Preparation of a Dry Blend of

1) a wood filler made from grounded powder of Pine Tree (particle size of 50 μm-1000 μm) with a mixture of natural binders such as Pectin, starch and Gluten powder was manually mixed until full homogenization. The dry blend was placed with a solvent such as Water and/or Glycerol in a sigma blade extruder for 2-30 mins.

The material achieved putty-like properties and then was extruded to shape, using different exit profiles (rectangles, Circles and other geometrical extrusion profiles) and was cut in different lengths and placed for drying at RT or various radiation sources (Infra-red, Thermal heating, microwave source). After the sample preparation, a post process of sanding/Polishing is made with wax coating as the final stage.

### Example 9—the First Stage is the Preparation of a Dry Blend of

1) a wood filler made from grounded powder of Pine Tree (particle size of 50 μm-1000 μm) with a mixture of natural binders such as Pectin, starch and alginate powder was manually mixed until full homogenization. The dry blend was placed with a solvent such as Water and/or Glycerol in an industrial planetary mixer for 2-30 mins.

The material achieved putty-like properties and then was inserted into a mold and pressed using Hydraulic press (at 2500-20000 psi). Then the final shaped sample was removed from the mold and placed for drying at RT or various radiation sources (Infra-red, Thermal heating, microwave source). After the sample preparation, a post process of sanding/Polishing is made with wax coating as the final stage.

1.-81. (canceled)

82. A molding composition comprising at least one filler, at least one natural binder and water, wherein the at least one filler is a plant-based filler or a natural inorganic filler, the composition being for use in a method of manufacturing wood-like objects.

83. The composition according to claim 82, being in a flowable form or being a putty-like material.

84. The composition according to claim 82, having a viscosity higher than 100K cP but lower than 300M cP.

85. The composition according claim 82, wherein the at least one plant-based filler is a powder obtained from ground tree material, ground dried leaves, or ground wood waste.

86. The composition according to claim 85, wherein the powder is provided as particles having a size ranging from 1 μm to 1 cm.

87. The composition according to claim 82, wherein the at least one filler is a waste wood material.

88. The composition according to claim 82, wherein the inorganic filler is selected to modulate density, appearances and physical properties of the wood-based object.

89. The composition according to claim 82, wherein the at least one binder is at least one plant-derived binder or an animal derived binder.

90. The composition according to claim 82, wherein the at least one binder is a protein-based binder.

91. The composition according to claim 90, wherein the protein-based protein is derived from eggs, milk and milk products, nuts, legumes and beans.

92. The composition according to claim 90, wherein the protein-based binder is a milk protein and a soy protein.

93. The composition according to claim 90, comprising at least one filler and at least one protein-based binder selected from actin, collagen, dystrophin, elastin, fibrin, keratin, myosin, nebulin, pikachurin, titin, tropomyosin, tubulin, casein, ferritin, gliadin, kafirin, oryzin, zein, and whey protein.

94. The composition according to claim 90, wherein the composition comprises at least one filler and at least one protein selected from actin, collagen, dystrophin, elastin, fibrin, keratin, myosin, nebulin, pikachurin, and titin.

95. The composition according to claim 90, wherein the composition comprises at least one filler and at least one protein selected from casein, ferritin, gliadin, kafirin, oryzin, and zein.

96. The composition according to claim 82, wherein the at least one binder is a biomaterial selected from a protein, a carbohydrate, a sugar, a biopolymer, and a fibrous material.

97. The composition according to claim 82, wherein the at least one filler is a powder obtained from ground tree material, ground dried leaves, or ground natural wood waste.

98. The composition according to claim 82 comprising the at least one filler in a form of a powder obtained from ground tree material, ground dried leaves, or ground natural wood waste, and at least one protein-based binder selected from milk proteins, casein protein, hydrolyzed casein protein, collagen protein, and hydrolyzed collagen proteins.

99. A process for manufacturing a wood-based object, the process comprising introducing a composition according to claim 82 into a mold, allowing said composition to fill said mold, and permitting said composition to dry to provide the object.

100. A toolholder securely and reversibly associated to a surface region of a tool, wherein the toolholder is formed of a material composition according to claim 82.

101. The toolholder according to claim 100, having a surface embedding a fracture line or fracture surface defining a breaking line, allowing for facile breaking (by hand, not requiring any tools) of the toolholder and release of the tool.
